(19) United States
(12) Patent Application Publication
(10) Pub. No.: US 2009/0240454 A1
(43) Pub. Date: Sep. 24, 2009

(54) METHOD AND SYSTEM FOR VALIDATING A PROCESSOR IN A SEMICONDUCTOR ASSEMBLY

(76) Inventor: Priyadarsan Patra, Portland, OR (US)

Correspondence Address: INTEL/BSTZ;BLAKELY SOKOLOFF TAYLOR & ZAFMAN LLP, 1279 OAKMEAD PARKWAY, SUNNYVALE, CA, 94085-4040, US

(21) Appl. No.: 12/054,277

(22) Filed: Mar. 24, 2008

(51) Int. Cl. G06F 19/00

(52) U.S. Cl. 702/81

(57) ABSTRACT

A method of conducting validation is provided. The method includes providing a processor that does not include a validation function and providing an auxiliary die coupled to the processor. The method also includes receiving validation data from the processor in the auxiliary die and conducting validation of the processor in the auxiliary die.

### BACKGROUND

Because of the complexity of the modern chip designs for processors and the increasing pressure to reduce their time-to market, errors may escape verification and instead be found during post-silicon validation of the fabricated chips. Current post-silicon validation and debug techniques for processors are expensive due to high cost of probing hardware such as logic analyzers and probes required for the validation. Further, use of such components perturbs the debug environment, introduces artificial latencies in the system, and makes customer validation of the chips expensive or difficult.

A traditional validation technique uses debug hooks on the processor die for performing the validation. However, these debug hooks complicate the design and typically serve no other purpose than for in-house post silicon debug and validation. Therefore, these additional silicon features often go unused but occupy space and consume power.

### BRIEF DESCRIPTION OF THE DRAWINGS

Features of embodiments of the claimed subject matter will become apparent as the following detailed description proceeds, and upon reference to the drawings, in which like numerals depict like parts, and in which:

FIG. 1 illustrates an embodiment of a semiconductor assembly;

FIG. 2 illustrates an exemplary process for post-silicon validation of the processor of FIG. 1;

FIG. 3 illustrates an exemplary configuration of coupling between the processor and the auxiliary die of FIG. 1;

FIG. 4 is a cross-section of the processor and the coupled auxiliary die of FIG. 3;

FIG. 5 illustrates another exemplary configuration of coupling between the processor and the auxiliary die of FIG. 1; and

FIG. 6 illustrates an embodiment of a computer system.

Although the following Detailed Description will proceed with reference being made to illustrative embodiments of the claimed subject matter, many alternatives, modifications, and variations thereof will be apparent to those skilled in the art. Accordingly, it is intended that the claimed subject matter be viewed broadly, and be defined only as set forth in the accompanying claims.

### DETAILED DESCRIPTION

As discussed in detail below, the embodiments of the present invention function to provide a system and a method for performing validation of a processor, such as a central processing unit (CPU) or a system-on-chip, which is housed in a semiconductor assembly. In particular, the present technique provides a method of transferring a validation function of the processor to an auxiliary die for performing post-silicon validation of the processor. In addition, the auxiliary die may support other debug and validation operations such as runtime validation of the processor, debug of programs supported by the processor, and monitoring runtime security of the processor.

References in the specification to “one embodiment”, “an embodiment”, “an exemplary embodiment”, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure or characteristic in connection with other embodiments whether or not explicitly described.

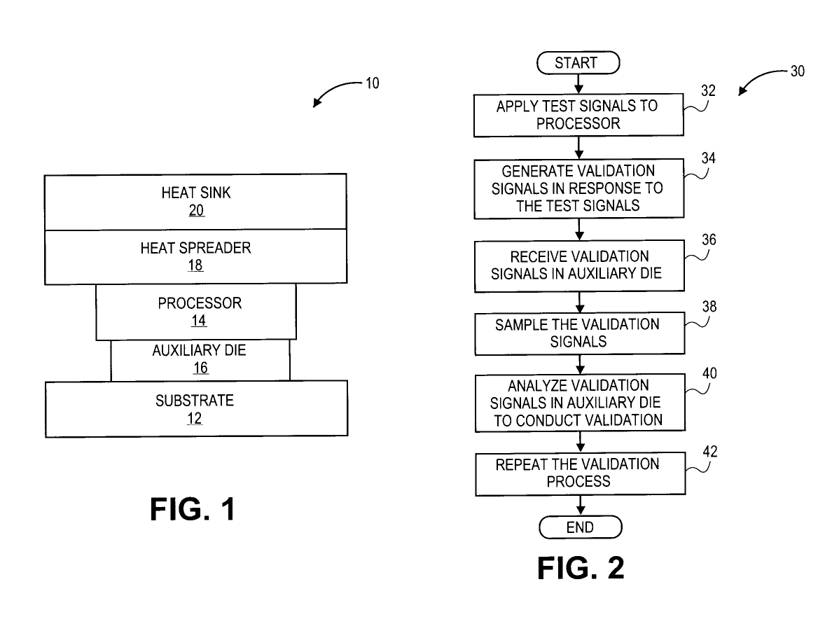

Referring first to FIG. 1, a semiconductor assembly 10 is illustrated. The semiconductor assembly 10 includes a substrate 12 and a processor 14 coupled to the substrate 12. The substrate 12 may be formed of a variety of materials including ceramic and printed circuit boards. In the illustrated embodiment, the processor 14 generates validation data such as validation signals for performing the post-silicon validation of the processor 14. In this exemplary embodiment, the validation signals arc generated in response to test signals applied to the processor 14. If the responses are correct for the test signals then the processor 14 may pass the verification. Alternatively, if the responses are not correct then the test signals that expose the errors form a bug trace that can be used to diagnose and correct the errors.

The semiconductor assembly 10 also includes an auxiliary die 16 coupled to the processor 14. In this embodiment, the auxiliary die 16 includes a validation function transferred from the processor 14. In particular, operations such as validation, debug observability and storage of signals are transferred from silicon and interconnect area of the processor 14 to the auxiliary die 16. Because the validation function is not supported by the processor 14, the size of the processor 14 may be less compared to processors that support the validation function. The reduction in size may save critical space within the assembly 10 and also reduce power consumption.

In certain embodiments, the auxiliary die 14 may include functionality for validation and debug such as filters to reduce collection of unwanted information, compression and decompression circuits to increase storage efficiency, and triggers for certain events in the processor 14 that need to be observed or responded to.

Further, the semiconductor assembly 10 includes a heat spreader 18 (e.g., a copper plate) and a heat sink 20 (e.g., a multi-fin heat sink) for dissipating the heat generated from the semiconductor assembly 10 to the surrounding environment. It should be noted that other thermal components, such as an active cooling system or a fluid cooling system may be used to dissipate heat generated from the semiconductor assembly 10. Such thermal components may be coupled to the processor 14 by a number of methods, e.g., by a layer of thermally conductive adhesive, by a layer of thermal grease, by a layer of solder material, by thermal vias, or by mechanical fasteners such as springs and clips.

In this exemplary embodiment, the auxiliary die 16 is disposed between the substrate 12 and the processor 14. However, other locations of the auxiliary die 16 may be envisaged. For example, the auxiliary die 16 and the processor 14 may be arranged in a multi-chip module configuration. In one embodiment, the auxiliary die 16 and the processor 14 may be arranged in a stacked configuration and are interconnected through wire-bonding or through-silicon-vias or electromagnetic coupling. In this exemplary embodiment, a thickness of the auxiliary die 16 is between about 20 micrometers to 100 micrometers. Further, the auxiliary die may be formed of materials such as active & bulk silicon, and metal.

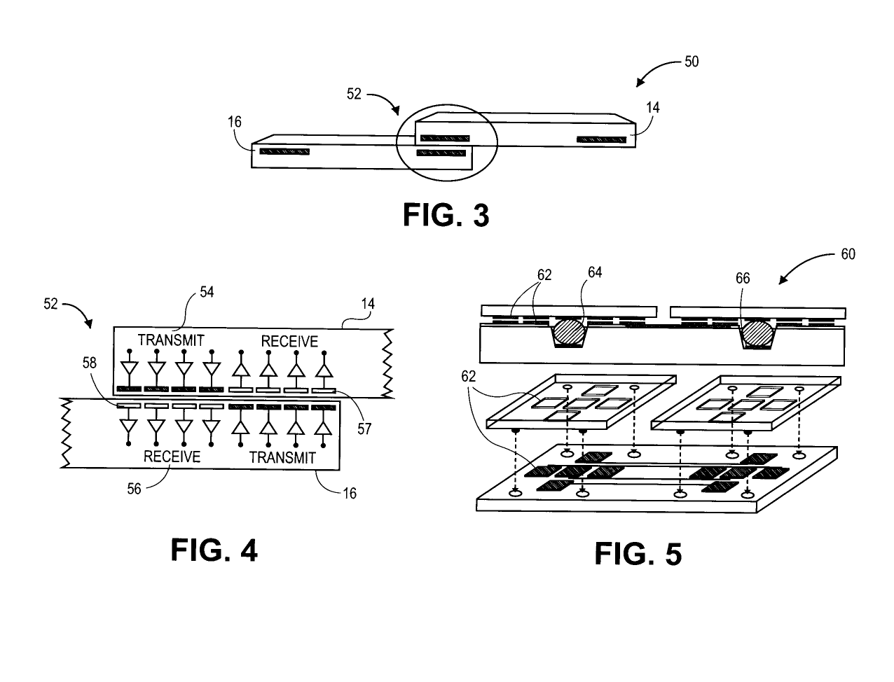

The auxiliary die 16 may be coupled to the processor 14 through a variety of techniques. In one exemplary embodiment, the auxiliary die 16 is coupled to the processor 14 through an electromagnetic coupling. In another embodiment, the auxiliary die 16 is coupled to the processor 14 through a plurality of silicon vias. In yet another embodiment, the auxiliary die 16 is coupled to the processor 14 through an optical coupling. Exemplary configurations of coupling between the auxiliary die 16 and the processor 14 are described below with reference to FIGS. 3-5.

In operation, the auxiliary die 16 receives the validation signals from the processor 14 and conducts the validation of the processor 14. In this exemplary embodiment, the validation signals are compressed and stored in the auxiliary die 16. Examples of the validation signals include, but are not limited to: Common System Interface (CSI) links, Fully Buffered Dual In-line Memory Module (FBD) registers addresses and values, Double Data Rate (DDR) memory register addresses and values, cache miss signals, Translation Lookaside Buffer (TLB) miss signals, branch miss signals, operation codes and Peripheral Connect Interface (PCIe) and coherence transaction signals. Such validation signals are subsequently analyzed in the auxiliary die 16 to identify any functional errors in the processor 14. Further, the auxiliary die 16 provides profiling and replay support for the post-silicon validation and debugging of the processor 14.

Transferring of the validation function of the processor 14 to the auxiliary die 16 reduces a die size of the processor 14, which preserves valuable space within semiconductor packages and assemblies. In certain embodiments, the processor 14 has a die size of about 5% less than a processor having the validation function. Transferring the validation function of the processor 14 to the auxiliary die 16 also reduces power consumption of the processor 14. In one exemplary embodiment, the processor 14 consumes about 2% less power than a processor having the validation function.

In certain embodiments, the auxiliary die 16 is configured to tune an application supported by the processor 14. Further, the auxiliary die 16 may be employed to monitor runtime security of the processor 14. In an exemplary embodiment, the auxiliary die 16 analyzes the validation signals to provide a parallel software debug capability for the processor 14. Additionally, the auxiliary die 16 may facilitate debugging of errors such as electrical errors in the processor 14 by introducing noise signals in the processor 14 and analyzing the response to such noise signals. In certain embodiments, the auxiliary die 16 may also be utilized for software development.

As described above, the auxiliary die 16 may be utilized for performing a plurality of validation and debug functions. Further, the auxiliary die 16 may be used for tuning an application supported by the processor 14 and for software development. The auxiliary die 16 may be selectively coupled to the processor 14 for off-loading certain validation and debug functions of the processor 14 to the auxiliary die 16.

The selective coupling of the auxiliary die 16 to the processor 14 reduces a die size of the processor 14 thereby resulting in cost savings and conservation of precious space. In one exemplary embodiment, manufacturing volume of the auxiliary die 16 is less than about 0.1% of the processor volume and is able to perfonn required in-house validation as well as validation or application-tuning at customer premises. Therefore, the coupling hooks left available within the processor 14 may be connected to the auxiliary die 16 to process signals and states for debug and validation of the processor 14. In one embodiment, there is a one-way communication between the processor 14 and the auxiliary die 16 for observability and analysis of the signals. In another embodiment, there is a two-way communication between the processor 14 and the auxiliary die 16 for controlling the operation of the auxiliary die 16 or to control the processor 14 to generate required observation signals at a desired rate.

As will be appreciated by one skilled in the art the selective coupling of the auxiliary die 16 to the processor 14 reduces the overall cost of fabrication of the processor 14. Further, the coupling of the auxiliary die 16 may provide additional features such as software development and application tuning to customers thereby extending the usefulness of the debug hardware for the processor 14 beyond post-silicon validation. In one exemplary embodiment, the auxiliary die 16 includes a modular architecture that can be easily coupled or decoupled to the processor 14.

FIG. 2 illustrates an exemplary process 30 for post-silicon validation of the processor 14 of FIG. 1. At a block 32, a plurality of test signals are applied to the processor 14. In certain embodiments, a validation plan is prepared to define the criteria for the debug process to be complete and to define the test signals. Further, the processor 14 generates validation signals in response to the plurality of test signals applied to the processor in a block 34. At a block 36, the validation signals are received by the auxiliary die 16 to perform the validation and debug of the processor 14.

The auxiliary die performs the sampling of the validation signals over a period of time to monitor and record the signals in a block 38. In certain embodiments, the validation signals are compressed and stored in the auxiliary die 16 for performing an on-site or off-site analysis of the signals. At step 40, the stored validation signals are analyzed in the auxiliary die 16 to diagnose bugs or errors in the processor 14. Examples of errors include functional errors, electrical errors and manufacturing/yield errors. Subsequently, processor layout may be repaired to fix the diagnosed errors. The validation process is repeated until the processor meets the predetermined criteria for the validation to be complete in a block 42.

FIG. 3 illustrates an exemplary configuration 50 of coupling between the processor 14 and the auxiliary die 16. In this exemplary embodiment, the processor 14 and the auxiliary die 16 are coupled through a capacitive coupling, represented by reference numeral 52. A cross-section of the processor 14 and the coupled auxiliary die 16 is illustrated in FIG. 4.

As illustrated in FIG. 4, each of the processor 14 and the auxiliary die 16 includes transmitter and receiver circuits 54 and 56 built using on-chip structures. In this embodiment, the processor 14 and the auxiliary die 16 communicate by capacitive coupling, in which the transmitters 54 drive a plate of metal 57 on the processor 14 that couples to a corresponding plate of metal 58 on the auxiliary die 16. Further, this metal plate 58 in turn drives the receivers 56 on the processor 14. Thus, the processor 14 and the auxiliary die 16 communicate by capacitively coupling data between a pair of parallel plates 57 and 58, one on each of the processor 14 and the auxiliary die 16. As described previously, the validation signals from the processor 14 are communicated to the auxiliary die 16 through the parallel plates and the signals are analyzed to conduct validation in the auxiliary die 16.

FIG. 5 illustrates another exemplary configuration 60 of coupling between the processor 14 and the auxiliary die 16. In this exemplary embodiment, the processor 14 and the auxiliary die 16 are coupled through inductors 62 which are used to transfer the validation signals from the processor 14 to the auxiliary die 16 for conducting the validation of the processor 14. In this embodiment, solder bumping 64 is employed to provide DC connectivity between the processor 14 and the auxiliary die 16. Further, trenches such as represented by reference numeral 66 are provided in the auxiliary die 16 that recess the solders bump 64 deep enough to bring the processor 14 and the auxiliary die 16 into close proximity.

In certain embodiments, the inductive or capacitive coupling described above may be used to achieve less-expensive, contactless and high-bandwidth connections between the processor 14 and the auxiliary die 16. In one embodiment, an asymmetric optimization may be performed to reduce processing steps on the processor 14 and shift not only the validation functionality but also some of the wafer processing steps from the processor 14 die to the auxiliary die 16 in order to optimize the manufacturing cost. Such wafer processing steps may facilitate coupling or connection between the processor 14 and the auxiliary die 16 later for validation or debug of a very small population of selected processor dies. The capacitive or inductive coupling elements described above are scalable to provide high-density inter-chip connections.

As will be appreciated by one skilled in the art a variety of other coupling techniques may be employed to couple the auxiliary die 16 to the processor 14 for transferring the validation signals from the processor 14 to the auxiliary die.

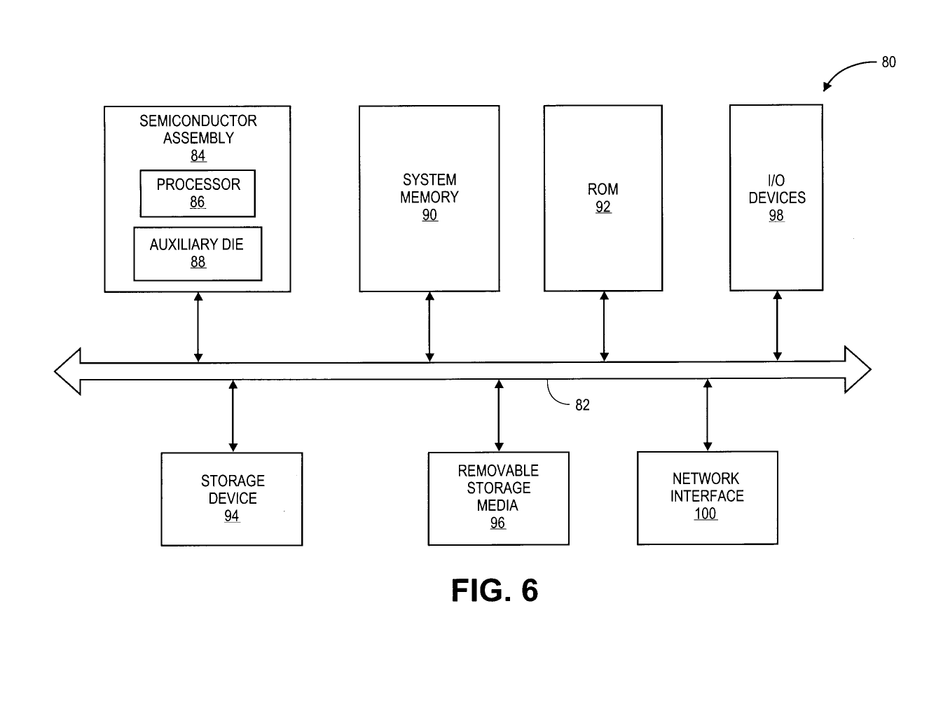

FIG. 6 illustrates an embodiment of a computer system 80. The computer system 80 includes a bus 82 to which the various components are coupled. In certain embodiments, the bus 82 includes a collection of a plurality of buses such as a system bus, a Peripheral Component Interface (PCI) bus, a Small Computer System Interface (SCSI) bus, etc. Representation of these buses as a single bus 82 is provided for ease of illustration, and it should be understood that the system 80 is not so limited. Those of ordinary skill in the art will appreciate that the computer system 80 may have any suitable bus architecture and may include any number of combination of buses.

A semiconductor assembly 84 is coupled to the bus 82. In the illustrated embodiment, the semiconductor assembly 84 includes a processor 86 and an auxiliary die 88 coupled to the processor 86. The processor 86 may include any suitable processing device or system, including a microprocessor (e.g., a single core or a multi-core processor), a network processor, an application specific integrated circuit (ASIC), or a field programmable gate array (FPGA), or any similar device. It should be noted that although FIG. 6 shows a single processor 86, the computer system 80 may include two or more processors.

The computer system further includes system memory 90 coupled to the bus 82. The system memory 90 may include any suitable type and number of memories, such as static random access memory (SRAM), dynamic random access memory (DRAM), synchronous dynamic random access memory (SDRAM), or double data rate DRAM (DDRDRAM). During operation of the computer system 80, an operating system and other applications may be resident in the system memory 90.

The computer system 80 may further include a read-only memory (ROM) 92 coupled to the bus 82. The ROM 92 may store instructions for the processor 86. The computer system 80 may also include a storage device (or devices) 94 coupled to the bus 82. The storage device 94 includes any suitable non-volatile memory, such as, for example, a hard disk drive. The operating system and other programs may be stored in the storage device 94. Further, a device 96 for accessing removable storage media (e.g., a floppy disk drive or a CD ROM drive) may be coupled to the bus 82.

The computer system 80 may also include one or more Input/Output (I/O) devices 98 coupled to the bus 82. Common input devices include keyboards, pointing devices such as a mouse, as well as other data entry devices. Further, common output devices include video displays, printing devices, and audio output devices. It will be appreciated that these are but a few examples of the types of I/O devices that may be coupled to the computer system 80.

The computer system 80 may further comprise a network interface 100 coupled to the bus 82. The network interface 100 comprises any suitable hardware, software, or combination of hardware and software that is capable of coupling the system 80 with a network (e.g., a network interface card). The network interface 100 may establish a link with the network over any suitable medium (e.g., wireless, copper wire, fiber optic, or a combination thereof) supporting exchange of information via any suitable protocol such as TCP/IP (Transmission Control protocol/Internet Protocol), HTTP (Hyper-Text Transmission Protocol), as well as others.

It should be understood that the computer system 80 illustrated in FIG. 6 is intended to represent an exemplary embodiment of such a system and, further, that this system may include any additional components, which have been omitted for clarity and ease of understanding. By way of example, the system 80 may include a direct memory access (DMA) controller, a chip set associated with the processor 86, additional memory (e.g., cache memory) as well as additional signal lines and buses. Also, it should be understood that the computer system 80 may not include all the components shown in FIG. 6. The computer system 80 may comprise any type of computing device, such as a desktop computer, a laptop computer, a server, a hand-held computing device, a wireless communication device, an entertainment system etc.

In this exemplary embodiment, the computer system 80 includes the auxiliary die 88 as described in the embodiments above. The auxiliary die 88 may be selectively coupled or decoupled to the processor 86 through the coupling mechanisms described above. In particular, the auxiliary die 88 may be coupled to the processor for transferring the validation function of the processor 86 to the auxiliary die 88, or to tune an application supported by the processor, or for software development, or to perform other operations described previously.

The foregoing detailed description and accompanying drawings are only illustrative and not restrictive. They have been provided primarily for a clear and comprehensive understanding of the disclosed embodiments and no unnecessary limitations are to be understood therefrom. Numerous additions, deletions, and modifications to the embodiments described herein, as well as alternative arrangements, may be devised by those skilled in the art without departing from the spirit of the disclosed embodiments and the scope of the appended claims.

1. A method of conducting validation, comprising:
providing a processor, wherein the processor does not include a validation function;
providing an auxiliary die coupled to the processor;
receiving validation data from the processor in the auxiliary die; and
conducting validation of the processor in the auxiliary die.

2. The method of claim 1, wherein the processor is one of a set of processors selected for validation.

3. The method of claim 2, wherein the set of processors selected for validation is about 0.1% of a total set of processors.

4. The method of claim 1, further comprising:
storing the validation signals in the auxiliary die; and
debugging the processor.

5. The method of claim 4, further comprising compressing the validation signals in the auxiliary die.

6. The method of claim 1, wherein the processor has a die size of about 5% less than a processor having the validation function.

7. The method of claim 1, wherein the processor consumes about 2% less power than a processor having the validation function.

8. The method of claim 1, wherein the validation data is received from the processor through electromagnetic coupling.

9. The method of claim 1, further comprising tuning an application supported by the processor through the auxiliary die.

10. The method of claim 9, further comprising monitoring runtime security of the processor through the auxiliary die.

11. The method of claim 9, further comprising providing a parallel software debug capability for the processor through the auxiliary die.

12. The method of claim 9, further comprising introducing noise signals into the processor through the auxiliary die to detect an error in the processor.

13. A semiconductor assembly, comprising:
a substrate;
a processor supported by the substrate, wherein the processor does not include a validation function; and
an auxiliary die coupled to the processor, wherein the auxiliary die comprises a validation function to receive validation data from the processor to conduct validation of the processor.

14. The semiconductor assembly of claim 13, wherein the auxiliary die is disposed between the substrate and the processor.

15. The semiconductor assembly of claim 13, wherein a manufacturing volume of the auxiliary die is between about 0.01% to about 0.1% of a manufacturing volume of the processor.

16. The semiconductor assembly of claim 13, wherein the auxiliary die is coupled to the processor through a capacitive coupling.

17. The semiconductor assembly of claim 13, wherein the auxiliary die is coupled to the processor through an inductive coupling.

18. The semiconductor assembly of claim 13, wherein the auxiliary die is coupled to the processor through silicon vias.

19. The semiconductor assembly of claim 13, wherein the auxiliary die is coupled to the processor through an optical coupling.

20. A method of manufacturing a semiconductor assembly, comprising:
providing a processor that does not include a validation function; and
selectively coupling an auxiliary die to the processor of the semiconductor; wherein the auxiliary die receives validation data from the processor and conducts validation of the processor.
